(19) United States
(12) Patent Application Publication
(10) Pub. No.: US 2016/0011667 A1
(43) Pub. Date: Jan. 14, 2016

(54) System and Method for Supporting Human Machine Interaction

(71) Applicant: Mitsubishi Electric Research Laboratories, Inc., Cambridge, MA (US)

(72) Inventor: Tyler W. Garaas, Brookline, MA (US)

(21) Appl. No.: 14/325,454

(22) Filed: Jul. 8, 2014

(51) Int. Cl. G06F 3/01

(52) U.S. Cl. CPC G06F 3/017; G06F 3/012; G06F 3/013; G06F 3/014

(57) ABSTRACT

A method for interacting with a set of systems, such as vehicle systems, first determines, using a sensor, a direction of interest of a user, such as the user gaze. One of the systems is selected based on the direction of interest, and a state is changed to correspond to the selected system. Input from the user is acquired using an input device, and then an action is performed on the selected system according to the state and the input.

### FIELD OF THE INVENTION

This invention relates generally to human machine interaction (HMI), and more specifically simplifying the HMI.

### BACKGROUND OF THE INVENTION

Often, a user desires to interact with machines, equipment and systems therein generally systems) to achieve some goal. However, many systems have a large number of potential interactions that are possible for the user to perform. For example, consider a vehicle. In addition to controls, generally input devices, for performing the primary task of driving the vehicle, e.g., steering, acceleration and deceleration, most vehicles also contain controls for adjusting entertainment, climate, navigation, seating systems. Typically each system has a dedicated set of controls, e.g., volume, fader and tuner for a radio, temperature and fan for climate, etc. To operate these controls, the driver often must divert attention significantly from driving to achieve the desired goal, e.g., changing the radio station.

One approach to relieving some difficulty of interacting with such systems to perform some task is to use a modal approach. In this manner, a control may have one functions when the system is in one mode, such as climate control, and another function when the system is in another mode, such as radio control. This approach can significantly reduce the number of input devices with which the user has to interact. However, to significantly reduce the number of input devices, a menu system would become extremely complex, and may lead to further user distraction and frustration.

Another approach that can reduce distractions in a vehicle operator is to use a head-up display (HUD) so that the driver does not have to divert their eye gaze while driving. However, the HUD does not solve the problem of having too many input devices for supporting the large number of interactions the systems provide.

U.S. 20140009390 describes a method for controlling a system based upon the gaze of a user. However, that method has some shortcomings for controlling a machine intuitively with the aid of gaze.

First, the system requires the user to gaze directly at a component of a graphical user interface (GUI) to select a specific action. This requirement has the effect that the input devices are dependently configured to make a gaze dependent action while actively gazing at the component, which can be problematic because of a phenomenon known as the eye-hand gap. The eye-hand gap is a delay in time in which the person performs an action related to the GUI component gazed at. However, at the time of the actual input action, such as the click of a mouse, the gaze has often already have moved from the object of interest to a subsequent component in which the operator is interested.

Second, because the operator must be gazing at the component while directing input, the user cannot redirect their gaze while continuing the action. For example, if the user wishes to alter the audio volume, the user must continue to stare at the volume control component.

### SUMMARY OF THE INVENTION

As shown in FIG. 1, the embodiments of the invention provide an apparatus and method for simplifying human machine interaction (HMI), and more specifically, to minimizing distractions while interacting with on-board vehicle systems 170 while driving a vehicle. The steps of the method can be performed in one or more processors 100 connected to memories

The invention significantly improves HMI by having the system change state based on an estimated direction of interest indicated by the user. The state of the system can then be used, for example, to alter the effect of input devices or the output of actuators for the system to facilitate successful completion of user interactions.

In one embodiment, a vehicle is equipped with a head-up display (HUD) showing status of various in vehicle systems. The user can select various display components and change state accordingly. Then, a single input device can assume control functions associated with the component. The direction of interest can be determined by eye or head pose tracking.

### BRIEF DESCRIPTION OF THE DRAWINGS

FIG. 1 is a flow diagram of a method for human machine interaction (HMI) according to embodiments of the invention; and

FIG. 2 is a schematic of an apparatus for HMI according to embodiments of the invention.

### DETAILED DESCRIPTION OF THE PREFERRED EMBODIMENTS

The embodiments of the invention provide an apparatus and method for simplifying human machine interaction (HMI), and more specifically, to minimizing distractions while interacting with a set of on-board systems while driving a vehicle.

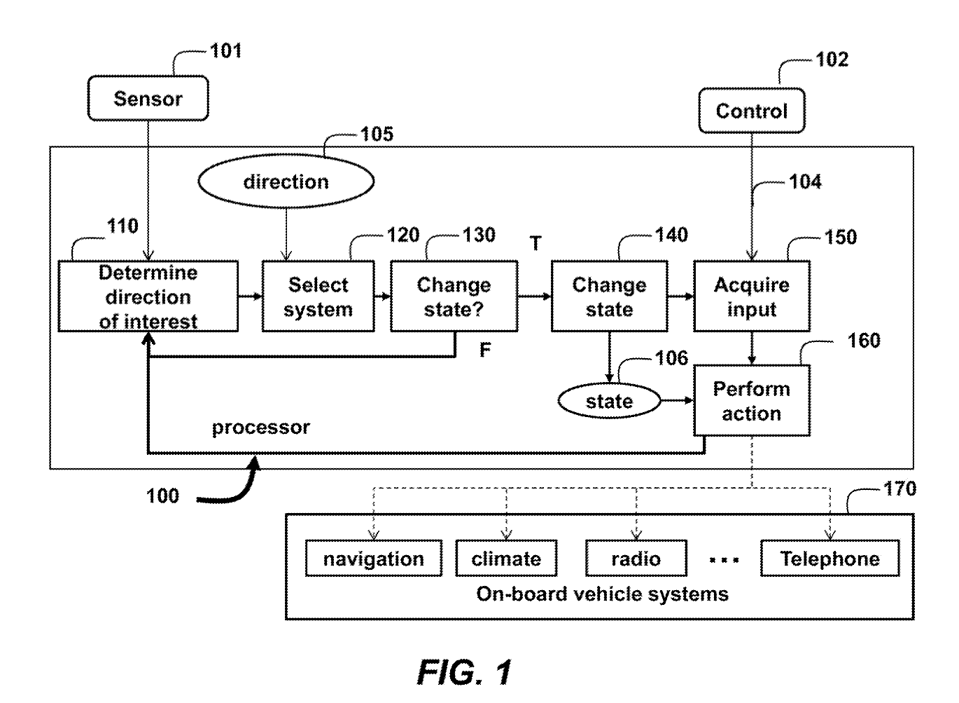

FIG. 1 shows the method according to the embodiments. A sensor 101 is used to determine 110 a direction of interest 105. The direction of interest can be determined in a variety of manners, including eye tracking, head-pose tracking, finger tracking, arm tracking, neural pattern tracking or a combination thereof. The interest can be directed at one of the system, a head up display (HUD), a physical object or a virtual object.

The direction of interest is used to select 120 one of the systems in the set 170. This is followed by a determination to change 130 the state 106, or not. If the state is not to be changes (F), e.g., because the selected system is the same as the current system, continue at step 110, otherwise (T) change 140 the state to be that of the selected system. The states can be maintained as a finite state machine. Then, input 104 is acquired 150 from a control 102, and an action is performed 160 on the selected accordingly.

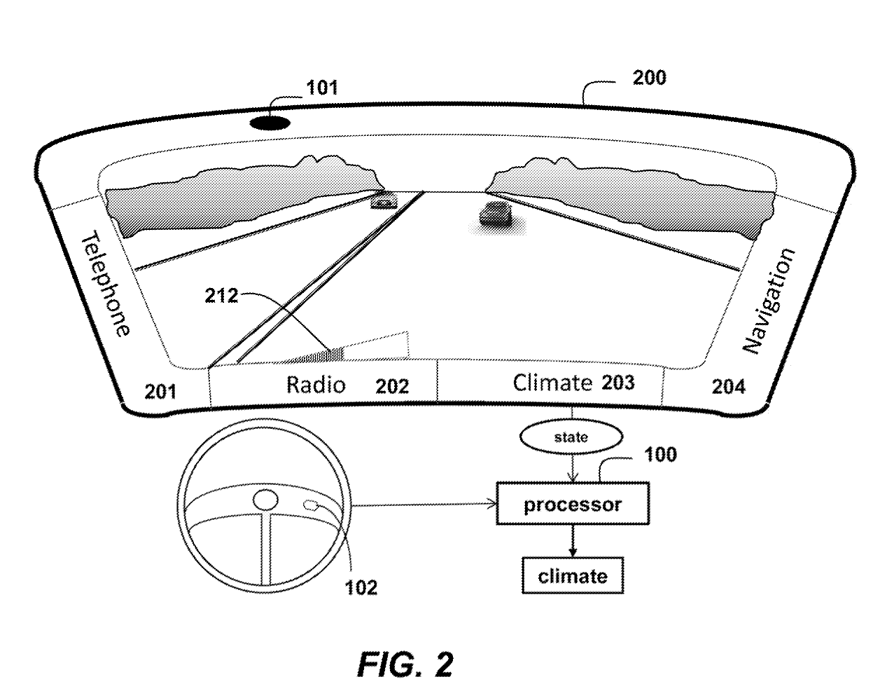

FIG. 2 shows an apparatus according the embodiments. In this embodiment, the HUD 200 is used. The HUD can be configured to have multiple context areas 201-204 around the periphery of the display. There is one area for each system in the set 170. When the driver gazes at a specific area, the state 106 is switched from a previous state to a next state associated with the area at which the user is gazing. Head pose can also be used.

For example, if the driver gazes at the radio area 202, various other areas of the HUD. The areas can be graphical component on a display screen, e.g., the windscreen, or icons. The components can correspond to display radio-relevant information, such as the station frequency and volume 212, etc. Additionally, an input device or control 102, such as a scroll wheels or slider arranged on to the steering wheel can automatically have the effect diverted from, for example, controlling the vehicle climate to the radio volume 212. In this way, the operator is never required to significantly move either their gaze from the road, or the hands from the steering wheel so that the primary task of driving the vehicle can be performed without distractions. The input can also be obtained by a speech or gesture recognition system.

The apparatus and method are actively monitoring the direction of interest of the user, and when the interest is directed at a known system (real, or virtual as in a HUD) with an associated state, the state is changed to agree with the selected system.

The act of altering the state does not always necessarily have to be a discrete change. Instead it could be a probabilistic measure of the user's interest in, or awareness of, an object.

In an alternative embodiment, as in a non-deterministic state machine, multiple states can be maintained concurrently to possibly avoid conditions where a user gazes at a system of interest but with no active intent of altering the state of the system.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

I claim:

1. A method for interacting with a set of systems, comprising steps:
determining, using a sensor, a direction of interest of a user;
selecting one of the systems based on the direction of interest;
determining whether to change to a state corresponding to the selected system;
changing to the state corresponding to the selected system if true;
acquire input from the user using an input device; and
performing an action on the selected system according to the state and the input, wherein the steps are performed in a processor.

2. The method of claim 1, wherein the direction of interest is determined by eye tracking, head-pose tracking, finger tracking, arm tracking, neural pattern tracking or a combination thereof.

3. The method of claim 1, wherein the direction of interest towards a graphical component on a display screen.

4. The method of claim 3, wherein the graphical component is on a head-up display (HUD).

5. The method of claim 1, wherein the direction of interest is towards a physical component of one of the systems.

6. The method of claim 1, wherein the direction of interest is towards a virtual object.

7. The method of claim 1, wherein the user is a driver of a vehicle, and the systems are on-board the vehicle.

8. The method of claim 1, wherein the state is maintained in a finite state machine.

9. The method of claim 8, wherein the finite state machine is non-deterministic.

10. The method claim 1, where the state is probabilistic.

11. The method of claim 1, wherein the input device is arranged on a steering wheel.

12. The arrangement of claim 1, wherein the input device is a speech recognition system.

13. The arrangement of claim 1, wherein the input device is a gesture recognition system.

14. The method of claim 1, wherein the state alters an output of graphical components presented on a display for the user.

15. An apparatus for interacting with a set of systems comprising:
a non-transitory memory;
a sensor; and
a processor connected to the non-transitory memory and the sensor, wherein the processor determines a direction of interest of a user using the sensor, selects one of the systems based on the direction of interest, determines whether to change to a state corresponding to the selected system, changes to the state corresponding to the selected system if true, acquires input from a user using the input device, and performs an action on the selected system according to the state and input.

16. The apparatus of claim 15, wherein the user is a driver of a vehicle, and the systems are on-board the vehicle.
